(19) United States
(12) Patent Application Publication
(10) Pub. No.: US 2014/0272374 A1
(43) Pub. Date: Sep. 18, 2014

(54) PROCESS FOR PRODUCING COMPOSITE ELEMENTS

(71) Applicant: BASF SE, Ludwigshafen (DE)

(72) Inventors: Olaf JACOBMEIER, Luebbecke (DE); Gunnar KAMPF, Stemwede-Haldem (DE)

(73) Assignee: BASF SE, Ludwigshafen (DE)

(21) Appl. No.: 14/210,824

(22) Filed: Mar. 14, 2014

Related U.S. Application Data
(60) Provisional application No. 61/786,896, filed on Mar. 15, 2013.

(51) Int. Cl. C08J 9/14; C08J 9/12

(52) U.S. Cl. CPC C08J 9/141; C08J 9/125
USPC 428/304.4; 427/348

(57) ABSTRACT

The present invention relates to a process for producing composite elements comprising at least one rigid foam layer a) and at least one outer layer b), at least comprising: provision of a flowable starting material a*) and application of the flowable starting material a*) to the outer layer b) by means of a fixed application apparatus c) while the outer layer b) is moved continuously. The starting material a*) here comprises at least one polyisocyanate, at least one polyol, at least one blowing agent, a catalyst composition comprising at least one compound D1) selected from the group consisting of metal carboxylates and N,N′,N″-tris(dimethylaminopropyl)hexahydrotriazine, and at least one compound D2) which catalyzes polyurethane formation and which differs from the compound D1) and comprises at least one amino group, and optionally auxiliaries and additives. The polyol component (component B)) in this invention is one selected from polyetherols, and the starting material a*) in this invention is free from polyesterols. The present invention further relates to composite elements obtainable by a process of this type.

The present invention relates to a process for producing composite elements comprising at least one rigid foam layer a) and at least one outer layer b), at least comprising: provision of a flowable starting material a*) and application of the flowable starting material a*) to the outer layer b) by means of a fixed application apparatus c) while the outer layer b) is moved continuously. The starting material a*) here comprises at least one polyisocyanate, at least one polyol, at least one blowing agent, a catalyst composition comprising at least one compound D1) selected from the group consisting of metal carboxylates and N,N′,N″-tris(dimethylaminopropyl)hexahydrotriazine, and at least one compound D2) which catalyzes polyurethane formation and which differs from the compound D1) and comprises at least one amino group, and optionally auxiliaries and additives. The polyol component (component B)) in this invention is one selected from polyetherols, and the starting material a*) in this invention is free from polyesterols. The present invention further relates to composite elements obtainable by a process of this type.

Rigid polyurethane foams have been known for a long time and have been widely described. Rigid polyurethane foams are mainly used for thermal insulation, for example in refrigeration equipment, means of transport, or buildings, and also for producing construction elements, in particular sandwich elements.

Composite elements are a significant application sector for rigid polyurethane foams. Composite elements, often also termed sandwich elements, are nowadays produced on a large scale in continuously operating twin-belt systems, and are in particular made of metallic outer layers and of a core made of isocyanate-based foams, mostly polyurethane (PUR) foams or polyisocyanurate (PIR) foams.

Elements with colored outer layers for the construction of façades for a very wide variety of buildings are of constantly increasing importance, alongside sandwich elements for cold-store insulation. Outer layers used here comprise not only coated steel sheet but also stainless steel sheet, copper sheet, or aluminum sheet. The surface structure of the boundary between the foam and the outer layer has a decisive function in particular in the case of façade elements. For a very wide variety of reasons, undesired air inclusions known as cavities often occur between the outer layer and the isocyanate-based foam during production of the sandwich elements. Particularly when large temperature changes occur and when the lower outer layer in the façade-element application is dark-colored, these air inclusions between metal sheet and foam can cause bulging of areas of the metal sheet, and can render the façade visually unattractive.

Another result here is reduced adhesion between insulation foam and outer layer. The lower outer layer in sandwich elements often has the poorest adhesion, determined in the tensile test. In the usual structures produced by use of sandwich elements, the underside of the metal sheet is moreover the external side of the façade, and is thus exposed to extreme conditions, for example temperature and suction effects, and is therefore subject to greater stress than the upper side of the sandwich element; this can lead to separation of the foam from the metal sheet, and thus likewise to bulging.

WO 2009/077490 describes a process for producing composite elements comprising at least one outer layer b) and at least one layer made of isocyanate-based rigid foam. Although said process does provide rigid foam layers with a low level of surface defects (cavities) and with a good surface structure of the boundary between the foam and the adjacent outer layer, the surface structure of the foam is unsatisfactory.

The object is therefore to develop a process for producing rigid polyurethane foams and which provides long-lasting minimization, or indeed elimination, of cavity formation at that surface of the isocyanurate-based rigid foams that faces toward the upper outer layer, and thus leads to foaming with good adhesion, good surface curing, and good surface quality.

Said object is achieved in the invention via a process for producing composite elements comprising at least one rigid foam layer a) and at least one outer layer b), at least comprising the following steps:
(i) providing a flowable starting material a*)
(ii) applying the flowable starting material a*) to the outer layer b) by means of a fixed application apparatus c) while the outer layer b) is moved continuously,
   where the starting material a*) comprises the following components:
A) at least one polyisocyanate,
B) at least one polyol,
C) at least one blowing agent,
D) catalyst composition comprising
   at least one compound D1) selected from the group consisting of metal carboxylates and N,N′,N″-tris(dimethylaminopropyl)hexahydrotriazine;
   at least one compound D2) which catalyzes polyurethane formation and which differs from the compound D1) and comprises at least one amino group, and
E) optionally auxiliaries and additives,
   where component B) is one selected from polyetherols, and the starting material a*) is free from polyesterols.

Surprisingly, it has been found that the use of polyol components comprising polyether which are free from polyesterols improves curing and thus improves surface quality.

In this invention, the composite elements comprising at least one rigid foam layer a) and at least one outer layer b) are produced by first, in step (i), providing a flowable starting material a*), and then, in step (ii), applying the flowable starting material a*) to the outer layer b) by means of a fixed application apparatus c), while the outer layer b) is moved continuously.

In this invention, the starting material a*) comprises the following components:

A) at least one polyisocyanate,
B) at least one polyol,
C) at least one blowing agent,
D) catalyst composition comprising
   at least one compound D1) selected from the group consisting of metal carboxylates and N,N′,N″-tris(dimethylaminopropyl)hexahydrotriazine;
   at least one compound D2) which catalyzes polyurethane formation and which differs from the compound D1) and comprises at least one amino group, and
E) optionally auxiliaries and additives,
   where component B) is one selected from polyetherols, and the starting material a*) is free from polyesterols.

Catalysts (D) used for producing the rigid polyurethane foams comprise compounds which greatly accelerate the reaction of the compounds of component B) comprising reactive hydrogen atoms, in particular hydroxy groups, with the organic, optionally modified polyisocyanates A).

The catalyst composition D) in the invention comprises at least one compound D1) and at least one compound D2) which catalyzes polyurethane formation and which differs from the compound D1).

The catalysts can be used alone or in any desired mixtures with one another, as required. It is preferable to use an amount in the range from 0.1 to 3.2 parts by weight of catalyst component D1) and to use an amount of at least 0.1 part by weight of the catalyst component D2), where the stated amount (parts by weight) is always based on 100 parts by weight of component B).

The amount used of catalyst component D1) is more preferably in the range from 0.1 to 2.5 parts by weight, and particularly preferably in the range from 0.1 to 1.8 parts by weight, and specifically in the range from 0.1 to 1.0 part by weight, where the stated amount (parts by weight) is always based on 100 parts by weight of component B).

In another embodiment, the present invention accordingly provides a process for producing composite elements as described above where the amount used of the catalyst D1) is in the range from 0.1 to 2.5 parts by weight, based on 100 parts by weight of component B).

The proportion of catalyst component D2) is generally greater than or equal to 0.1% by weight, based on 100 parts by weight of component B), preferably greater than or equal to 0.6% by weight, particularly preferably greater than or equal to 1.2% by weight, with particular preference greater than or equal to 2.5% by weight, specifically preferably greater than or equal to 3.5% by weight, and specifically greater than or equal to 4.3% by weight.

The proportion of catalyst component D2) is generally less than or equal to 10% by weight, based on 100 parts by weight of component B), preferably less than or equal to 8% by weight, particularly preferably less than or equal to 7% by weight.

In another embodiment, the present invention accordingly provides a process for producing composite elements as described above where the amount used of the compound D2) is at least 0.1 part by weight, based on 100 parts by weight of component B).

The ratio of catalyst compound D2) to catalyst component D1) is generally less than or equal to 34, preferably less than or equal to 30, particularly preferably less than or equal to 26, with particular preference less than or equal to 22.

The ratio of catalyst compound D2) to catalyst component D1) is generally greater than or equal to 2, preferably greater than or equal to 5, particularly preferably greater than or equal to 10, and specifically greater than 14.

It is preferable here that the ratio by weight of the compound D2) to the compound D1) is greater than 8.

In another embodiment, the present invention accordingly provides a process for producing composite elements as described above where the ratio by weight of the compound D2) to the compound D1) is greater than 8.

Catalyst component D1) in the invention is one selected from the group consisting of metal carboxylates and N,N′,N″-tris(dimethylaminopropyl)hexahydrotriazine. For the purposes of the present invention it is preferable that the metal carboxylate is an alkali metal carboxylate or an alkaline earth metal carboxylate, particularly a potassium carboxylate.

In this invention it is preferable that the carboxylate is one selected from the group consisting of formate, ethylhexanoate, and acetate. Accordingly, for the purposes of the present invention suitable catalyst components D1) are those selected from the group consisting of alkali metal formates, alkali metal ethylhexanoates, alkali metal acetates, alkaline earth metal formates, alkaline earth metal octanoates, and alkaline earth metal acetates, and N,N′,N″-tris(dimethylaminopropyl)hexahydrotriazine. It is particularly preferable that catalyst component D1) is one selected from the group consisting of potassium formate, potassium octanoate, potassium acetate, and N,N′,N″-tris(dimethylaminopropyl)hexahydrotriazine.

It is preferable that catalyst component D1) comprises a combination of crosslinking catalysts composed of
d11) from 0.1 to 1.0 part by weight, based on component B), of a crosslinking catalyst selected from the group consisting of the salt of a carboxylic acid, preferably of an alkali metal or alkaline earth metal, particularly preferably an alkali metal salt of a carboxylic acid, and
d12) from 0 to 3.0 parts by weight, based on component B), of the crosslinking catalyst N,N′,N″-tris(dimethylaminopropyl)hexahydrotriazine.

Catalyst components d11) used preferably comprise salts of carboxylic acids selected from the group consisting of formic acid, acetic acid, and octanoic acid, and it is particularly preferable to use formic acid and acetic acid, and specifically acetic acid.

In another embodiment, the present invention accordingly provides a process for producing composite elements as described above where the carboxylate is one selected from the group consisting of formate, octanoate, and acetate.

In another embodiment, the present invention accordingly provides a process for producing composite elements as described above where the catalyst composition comprises at least one potassium carboxylate and N,N′,N″-tris(dimethylaminopropyl)hexahydrotriazine.

It is particularly preferable that the ratio of catalyst component d12) to catalyst component d11) is smaller than 25, preferably smaller than 15, particularly preferably smaller than 10, and specifically smaller than 7.

Specifically, catalyst component d12) is not used, i.e. catalyst component D1) is composed exclusively of catalyst component d11).

Compounds suitable as catalyst component D2) are strongly basic amines, for example amidines, such as 2,3-dimethyl-3,4,5,6-tetrahydropyrimidine, tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, tetramethyldiaminoethyl ether, bis(2-dimethylaminoethyl)ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, N,N-dimethylaminoethoxyethanol, N,N,N′-trimethylaminoethylethanolamine and dimethylethanolamine.

The compound D2) is more preferably one selected from the group consisting of amidines, tertiary amines, and alkanolamines.

In another embodiment, the present invention accordingly provides a process for producing composite elements as described above where the compound D2) is one selected from the group consisting of amidines, tertiary amines, and alkanolamines.

It is particularly preferable to use triethylamine, dimethylcyclohexylamine, pentamethyldiethylenetriamine, or bis(2-dimethylaminoethyl)ether.

In particular, it is preferable to use triethylamine and dimethylcyclohexylamine, and more preferable to use triethylamine.

Component A

For the purposes of the present invention, the term polyisocyanate means an organic compound which comprises at least two reactive isocyanate groups per molecule, i.e. the functionality is at least 2. To the extent that the polyisocyanates used, or a mixture of a plurality of polyisocyanates, do/does not have uniform functionality, the number-average functionality of component A) used is at least 2.

Polyisocyanates A) that can be used are the aliphatic, cycloaliphatic, and araliphatic polyisocyanates known per se, and preferably the aromatic polyfunctional isocyanates. Polyfunctional isocyanates of this type are known per se or can be produced by methods known per se. The polyfunctional isocyanates can in particular also be used in the form of mixtures, and in this case component A) comprises various polyfunctional isocyanates. Polyfunctional isocyanates that can be used as polyisocyanate have two (these compounds being termed diisocyanates hereinafter) or more than two isocyanate groups per molecule.

The following individual compounds may in particular be mentioned: alkylene diisocyanates having from 4 to 12 carbon atoms in the alkylene moiety, for example dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates, such as cyclohexane 1,3- and 1,4-diisocyanate, and also any desired mixtures of said isomers, 1-isocyanato-3,3,5-trimethyl-5-isocyanatomethylcyclohexane (IPDI), hexahydrotolylene 2,4- and 2,6-diisocyanate, and also the corresponding isomer mixtures, dicyclohexylmethane 4,4′-, 2,2′-, and 2,4′-diisocyanate, and also the corresponding isomer mixtures, and preferably aromatic polyisocyanates, such as tolylene 2,4- and 2,6-diisocyanate and the corresponding isomer mixtures, diphenylmethane 4,4′-, 2,4′-, and 2,2′-diisocyanate and the corresponding isomer mixtures, mixtures of diphenylmethane 4,4′- and 2,2′-diisocyanates, polyphenyl polymethylene polyisocyanates, mixtures of diphenylmethane 4,4′-, 2,4′-, and 2,2′-diisocyanates and of polyphenyl polymethylene polyisocyanates (crude MDI), and mixtures of crude MDI and of tolylene diisocyanates.

In particular, suitable compounds are diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate, and/or p-phenylene diisocyanate (PPDI), tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and dicyclohexylmethane 4,4′-, 2,4′-, and/or 2,2′-diisocyanate.

The following embodiments are particularly preferred as polyisocyanates of component A):
i) polyfunctional isocyanates based on tolylene diisocyanate (TDI), in particular 2,4-TDI or 2,6-TDI, or a mixture of 2,4- and 2,6-TDI;
ii) polyfunctional isocyanates based on diphenylmethane diisocyanate (MDI), in particular 2,2′-MDI or 2,4′-MDI or 4,4′-MDI, or oligomeric MDI, which is also termed polyphenyl polymethylene isocyanate, or a mixture of two or three of the abovementioned diphenylmethane diisocyanates, or crude MDI, which arises during the production of MDI, or a mixture of at least one oligomer of MDI and of at least one of the abovementioned low-molecular-weight MDI derivatives;
iii) mixtures of at least one aromatic isocyanate of embodiment i) and of at least one aromatic isocyanate of embodiment ii).

Polymeric diphenylmethane diisocyanate is very particularly preferred as polyisocyanate. Polymeric diphenylmethane diisocyanate (hereinafter termed polymeric MDI) involves a mixture of binuclear MDI and of oligomeric condensates and thus of derivatives of diphenylmethane diisocyanate (MDI). The polyisocyanates can preferably also be composed of mixtures of monomeric aromatic diisocyanates and of polymeric MDI.

Polymeric MDI comprises, alongside binuclear MDI, one or more polynuclear condensates of MDI with a functionality of more than 2, in particular 3 or 4 or 5. Polymeric MDI is known and is often termed polyphenyl polymethylene isocyanate or else oligomeric MDI. Polymeric MDI is usually composed of a mixture of MDI-based isocyanates with different functionality. Polymeric MDI is usually used in a mixture with monomeric MDI.

The (average) functionality of a polyisocyanate which comprises polymeric MDI can vary in the range from about 2.2 to about 5, in particular from 2.3 to 4, in particular from 2.4 to 3.5. A particular mixture of this type comprising MDI-based polyfunctional isocyanates with different functionalities is crude MDI, which is obtained as intermediate during the production of MDI.

Polyfunctional isocyanates, and mixtures of a plurality of polyfunctional isocyanates, based on MDI, are known and are by way of example marketed as Lupranat® by BASF Polyurethanes GmbH.

The functionality of component A) is preferably at least two, in particular at least 2.2, and particularly preferably at least 2.4. The functionality of component A) is preferably from 2.2 to 4, and particularly preferably from 2.4 to 3.

The content of isocyanate groups in component A) is preferably from 5 to 10 mmol/g, in particular from 6 to 9 mmol/g, particularly preferably from 7 to 8.5 mmol/g. The person skilled in the art is aware that the content of isocyanate groups in mmol/g and what is known as the equivalent weight in g/equivalent have a reciprocal relationship. The content of isocyanate groups in mmol/g is obtained from the content in % by weight as in ASTM D5155-96 A.

In one particularly preferred embodiment, component A) is composed of at least one polyfunctional isocyanate selected from diphenylmethane 4,4′-diisocyanate, diphenylmethane 2,4′-diisocyanate, diphenylmethane 2,2′-diisocyanate, and oligomeric diphenylmethane diisocyanate. For the purposes of this preferred embodiment, component A particularly preferably comprises oligomeric diphenylmethane diisocyanate, and has a functionality of at least 2.4.

The viscosity of component A) used can vary widely. The viscosity of component A) is preferably from 100 to 3000 mPa*s, particularly preferably from 200 to 2500 mPa*s.

Modified polyisocyanates are often also used, these being products which are obtained via chemical reaction of organic polyisocyanates, and which have at least two reactive isocyanate groups per molecule. Mention may in particular be made of polyisocyanates comprising ester, urea, biuret, allophanate, carbodiimide, isocyanurate, uretdione, carbamate, and/or urethane groups.

Examples of individual compounds that can be used are: organic, preferably aromatic polyisocyanates which comprise urethane groups and which have NCO contents of from 33.6 to 15% by weight, preferably from 31 to 21% by weight, based on the total weight, for example with low-molecular-weight diols, triols, dialkylene glycols, trialkylene glycols, or polyoxyalkylene glycols with molecular weights up to 6000, in particular with molecular weights up to 1500, modified diphenylmethane 4,4′-diisocyanate, modified diphenylmethane 4,4′- and 2,4′-diisocyanate mixtures, or modified crude MDI, or tolylene 2,4- and/or 2,6-diisocyanate, where the following may be mentioned by way of example as di- or polyoxyalkylene glycols which can be used individually or in the form of mixtures: diethylene and dipropylene glycol, polyoxyethylene, polyoxypropylene and polyoxypropylene polyoxyethylene glycols, and corresponding triols and/or tetrols.

Other suitable compounds are prepolymers comprising NCO groups and having NCO contents of from 25 to 3.5% by weight, preferably from 21 to 14% by weight, based on the total weight, produced from the polyester polyols described hereinafter and/or preferably from the polyether polyols described hereinafter, and diphenylmethane 4,4′-diisocyanate, mixtures of diphenylmethane 2,4′- and 4,4′-diisocyanate, and of tolylene 2,4- and/or 2,6-diisocyanates, or crude MDI.

Other compounds that have proven successful are liquid polyisocyanates comprising carbodiimide groups and/or comprising isocyanurate rings and having NCO contents of from 33.6 to 15% by weight, preferably from 31 to 21% by weight, based on the total weight, e.g. based on diphenylmethane 4,4′-, 2,4′-, and/or 2,2′-diisocyanate and/or tolylene 2,4- and/or 2,6-diisocyanate.

The modified polyisocyanates can optionally be mixed with one another or with unmodified organic polyisocyanates, such as diphenylmethane 2,4′- or 4,4′-diisocyanate, crude MDI, or tolylene 2,4- and/or 2,6-diisocyanate. The following polyisocyanates have proven particularly successful and are preferably used: mixtures of tolylene diisocyanates and crude MDI, or mixtures of modified organic polyisocyanates comprising modified urethane groups and having an NCO content of from 33.6 to 15% by weight, in particular those based on tolylene diisocyanates, on diphenylmethane 4,4′-diisocyanate, or on diphenylmethane diisocyanate isomer mixtures, or crude MDI, and in particular crude MDI with a diphenylmethane diisocyanate isomer content of from 25 to 80% by weight, preferably from 30 to 55% by weight.

Component B

In the invention, component B) is one selected from polyetherols, and the starting material a*) is free from polyesterols.

Polyether polyols can be produced by known processes, for example via anionic polymerization with alkali metal hydroxides, e.g. sodium hydroxide or potassium hydroxide, or with alkali metal alcoholates, e.g. sodium methoxide, sodium ethoxide, or potassium ethoxide, or potassium isopropoxide, as catalysts, and with addition of at least one starter molecule which comprises from 2 to 8, preferably from 2 to 6, reactive hydrogen atoms, or via cationic polymerization with Lewis acids, such as antimony pentachloride, boron fluoride etherate, inter alia, or bleaching earth, as catalysts, from one or more alkylene oxides having from 2 to 4 carbon atoms in the alkylene moiety. It is also possible to use multimetal cyanide compounds, known as DMC catalysts. Tertiary amines can also be used as catalyst, an example being triethylamine, tributylamine, trimethylamine, dimethylethanolamine, imidazole, and/or dimethylcyclohexylamine.

Examples of alkylene oxides suitable for producing the polyether polyols b1), b2), and b3) are ethylene oxide, propylene 1,2-oxide, propylene 1,3-oxide, butylene 1,2- and/or 2,3-oxide, tetrahydrofuran, and styrene oxide, preferably ethylene oxide and propylene 1,2-oxide. The alkylene oxides can be used individually in alternating succession, or in the form of mixtures.

In one preferred embodiment of the invention, a mixture of
b1) from 35 to 75 parts by weight of one or more high-functionality polyether alcohols with functionalities of from 3.5 to 5.5 and with a hydroxy number of from 400 to 550 mg KOH/g,
b2) from 2 to 30 parts by weight of one or more polyether alcohols based on aliphatic amines with functionalities of from 3.5 to 4.5 and with a hydroxy number of from 450 to 900 mg KOH/g, and
b3) from 15 to 35 parts by weight of one or more polyether alcohols with functionalities of from 1.5 to 3 and with a hydroxy number of from 150 to 450 mg KOH/g is used as component B).

The sum of the parts by weight of b1) to b3) of component B) is defined as not exceeding 100 parts by weight.

The hydroxy number is determined as in DIN 53240.

In another embodiment, the present invention accordingly provides a process for producing composite elements as described above where a mixture of
b1) from 35 to 75 parts by weight of one or more high-functionality polyether alcohols with functionalities of from 3.5 to 5.5 and with a hydroxy number of from 400 to 550 mg KOH/g,
b2) from 2 to 30 parts by weight of one or more polyether alcohols based on aliphatic amines with functionalities of from 3.5 to 4.5 and with a hydroxy number of from 450 to 900 mg KOH/g, and
b3) from 15 to 35 parts by weight of one or more polyether alcohols with functionalities of from 1.5 to 3 and with a hydroxy number of from 150 to 450 mg KOH/g
   is used as component B).

The following compounds can be used as starter molecules for the polyether alcohols b1), b2), and b3) used in the invention:

b1) In particular, hydroxylated high-functionality compounds, in particular sugars, starch or lignin, are used as starter substances. Glucose, sucrose, and sorbitol are of particular industrial significance here. Since these compounds are solid under the usual reaction conditions of alkoxylation, it is generally usual to alkoxylate said compounds together with coinitiators. Particularly suitable coinitiators are water and lower polyhydric alcohols, e.g. glycerol, trimethylolpropane, pentaerythritol, ethylene glycol, diethylene glycol, propylene glycol, and homologues of these.
b2) Particular starter molecules used are ammonia, polyfunctional aliphatic amines, in particular those having from 2 to 6 carbon atoms and having primary and secondary amino groups, and also amino alcohols having from 2 to 6 carbon atoms in the main chain. It is preferable to use ethylamine, monoalkylethylenediamines, 1,3-propylenediamine, diethanolamine, and triethanolamine.
b3) Starter substances used are water and/or low-molecular-weight di- or trihydric alcohols. In particular, linear or branched alcohols having from 2 to 12 carbon atoms are used, in particular those having from 2 to 6 carbon atoms in the main chain. Examples of preferred compounds used as starter substances are, alongside water, glycerol, trimethylolpropane, ethylene glycol, propylene glycol, diethylene glycol, dipropylene glycol, 1,4-butanediol, 1,6-hexanediol, and homologues of these.

The polyether alcohols b1) preferably have functionalities of from 3.7 to 5.2 and a hydroxy number of from 400 to 520 mg KOH/g, and particularly preferably have functionalities of from 3.9 to 5 and a hydroxy number of from 400 to 500 mg KOH/g, and very particularly preferably have functionalities of from 4 to 4.5 and a hydroxy number of from 450 to 500 mg KOH/g.

The proportion of component b1) is preferably from 35 to 75 parts by weight, particularly preferably from 46 to 74 parts by weight, and specifically from 57 to 72 parts by weight, based on component B).

Polyether alcohols b2) preferably have a functionality of 4.0 and a hydroxy number of from 470 to 800 mg KOH/g, and particularly preferably a functionality of 4 and a hydroxy number of from 730 to 800 mg KOH/g.

The proportion of component b2) is preferably from 2 to 30 parts by weight, particularly preferably from 3 to 22 parts by weight, and specifically from 6 to 18 parts by weight, based on component B).

Polyether alcohols b3) with functionalities of from 2 to 3 and with a hydroxy number of from 220 to 430 mg KOH/g

In another embodiment, the present invention accordingly provides a process for producing composite elements as described above where the polyether alcohol(s) b3) has/have functionality/functionalities of from 2 to 3 and a hydroxy number of from 220 to 430 mg KOH/g.

Particular preference is given to polyether alcohols b3) with a functionality of 3 and with a hydroxy number of from 380 to 420 mg KOH/g.

The proportion of component b3) is preferably from 15 to 35 parts by weight, particularly preferably from 12.5 to 32 parts by weight, and specifically from 10 to 25 parts by weight, based on component B).

One or more polyether alcohols can be used as b3). Further information concerning the polyether alcohols b1), b2), and b3) used, and also concerning production of these, is found by way of example in Kunststoffhandbuch, Band 7 “Polyurethane” [Plastics handbook, volume 7, “Polyurethanes”], edited by Gunter Oertel, Carl-Hanser-Verlag, Munich, 3rd edition, 1993.

Component B) can also optionally comprise chain extenders and/or crosslinking agents.

Particular chain extenders and/or crosslinking agents used are di- or trifunctional amines and alcohols, in particular diols, triols, or both, in each case with molecular weights smaller than 400, preferably from 60 to 300.

It is also possible to use fatty-acid-modified polyether alcohols as component B).

For the purposes of the present invention, a fatty-acid-modified polyether polyol is a reaction product of at least one starter molecule with alkylene oxide and with at least one fatty acid and/or with at least one fatty acid derivative. Polyols of this type are known per se to the person skilled in the art.

In one preferred embodiment, the fatty-acid-modified polyetherol is the reaction product of
BF1) from 15 to 63% by weight, in particular from 20 to 55% by weight, of one or more polyols or polyamines with an average functionality of from 2.5 to 8,
BF2) from 2 to 30% by weight, in particular from 5 to 25% by weight, of one or more fatty acids and/or fatty acid monoesters,
BF3) from 35 to 83% by weight, in particular from 40 to 75% by weight, of one or more alkylene oxides having from 2 to 4 carbon atoms,
based in each case on the total amount of components BF1) to BF3), which gives 100% by weight.

If fatty-acid-modified polyetherols are used, it is preferable to omit use of polyetherol component b2), and it is particularly preferable to omit use of components b2) and b3), and specifically to omit use of components b1), b2), and b3).

Blowing agent C) used for the process of the invention can be the blowing agents usually used for producing rigid polyurethane foams.

Blowing agent C) used can comprise not only water but also well-known compounds having chemical and/or physical effect. The expression chemical blowing agents means compounds which form gaseous products via reaction with isocyanate, an example being water or formic acid. The expression physical blowing agents means compounds which have been emulsified or dissolved in the starting materials for polyurethane production and vaporize under the conditions of polyurethane formation. These involve by way of example hydrocarbons, halogenated hydrocarbons, and other compounds, for example perfluorinated alkanes, such as perfluorohexane, fluorochlorocarbons, and ethers, esters, ketones, acetals, and also inorganic and organic compounds which release nitrogen on heating, or a mixture thereof, for example (cyclo)aliphatic hydrocarbons having from 4 to 8 carbon atoms, or fluorocarbons, such as 1,1,1,3,3-pentafluoropropane (HFC245 fa), trifluoromethane, difluoromethanes, 1,1,1,3,3-pentafluorobutane (HFC 365 mfc), 1,1,1,2-tetrafluoroethane, difluoroethane and heptafluoropropane.

It is advantageous to use low-boiling-point aliphatic hydrocarbons as blowing agents, preferably n-pentane and/or isopentane, in particular n-pentane.

The boiling point of n-pentane is 36° C., and that of isopentane is 28° C. The boiling points are therefore within a range advantageous for the blowing process.

Water is also suitable as blowing agent, alone or in combination with one of the blowing agents mentioned.

In another embodiment, the present invention accordingly provides a process for producing composite elements as described above where the blowing agent is one selected from the group consisting of n-pentane, isopentane, and water.

Since the aliphatic hydrocarbons suitable as blowing agents are combustible and explosive, the foaming systems must have the appropriate safety equipment that is also necessary when n-pentane is used as blowing agent.

It is advantageous to use the aliphatic hydrocarbons together with water as blowing agent. The amount used of aliphatic hydrocarbons is from 2 to 30% by weight, preferably from 6 to 19% by weight, based on component B). The proportion of water depends on the envelope density desired for the rigid polyurethane foam, and is generally from 1 to 5 parts by weight, in particular from 1.5 to 5 parts by weight, and very particularly from 2 to 5 parts by weight, of water, based on component B).

Auxiliaries and/or additives E) can optionally also be incorporated into the reaction mixture for producing the rigid polyurethane foams. Examples that may be mentioned are surfactant substances, foam stabilizers, cell regulators, fillers, dyes, pigments, flame retardants, hydrolysis stabilizers, and fungistatic and bacteriostatic substances.

Examples of surfactant substances that can be used are compounds which serve to promote the homogenization of the starting materials and optionally are also suitable for regulating the cell structure of the plastics. Examples that may be mentioned are emulsifiers, such as the sodium salts of castor oil sulfates, or of fatty acids, and also salts of fatty acids with amines, e.g. diethylamine oleate, diethanolamine stearate, diethanolamine ricinoleate, salts of sulfonic acids, e.g. the alkali metal or ammonium salts of dodecylbenzene- or dinaphthylmethanedisulfonic acid and ricinoleic acid; foam stabilizers, such as siloxane-oxalkylene copolymers and other organopolysiloxanes, ethoxylated alkylphenols, ethoxylated fatty alcohols, paraffin oils, castor oil esters or ricinoleic esters, Turkey red oil, and peanut oil, and cell regulators, such as paraffins, fatty alcohols, and dimethylpolysiloxanes. A suitable method for improving emulsifying effect, cell structure, and/or for stabilizing the foam is moreover to use the oligomeric acrylates described above with polyoxyalkylene and fluoroalkane moieties as side groups. The amounts usually used of the surfactant substances are from 0.01 to 5 parts by weight, based on 100 parts by weight of component B).

Fillers, in particular reinforcing fillers, are the following conventional materials known per se: organic and inorganic fillers, reinforcing agents, weighting agents, and agents to improve abrasion behavior in paints and coating compositions etc. Individual examples that may be mentioned are: inorganic fillers, such as silicatic minerals, e.g. phyllosilicates, such as antigoriteii, serpentine, hornblendes, amphiboles, chrysotile, talc powder; metal oxides, such as kaolin, aluminum oxides, titanium oxides, and iron oxides, metal salts, such as chalk and baryte, and inorganic pigments, such as calcium sulfide and zinc sulfide, and also glass, inter alia. It is preferable to use kaolin (china clay), aluminum silicate, and coprecipitates of barium sulfate and aluminum silicate, or else natural and synthetic fibrous minerals, such as wollastonite, or various-length fibers of metal and in particular of glass, where these may optionally have been sized. Examples of organic fillers that can be used are: carbon, melamine, colophony, cyclopentadienyl resins, and graft polymers, and also cellulose fibers, polyamide fibers, polyacrylonitrile fibers, polyurethane fibers, and polyester fibers based on aromatic and/or aliphatic dicarboxylic esters, and in particular carbon fibers.

The inorganic and organic fillers can be used individually or in the form of mixtures, and amounts of these advantageously incorporated into the reaction mixture are from 0.5 to 50% by weight, preferably from 1 to 40% by weight, based on the weight of the entirety of components A) and B), where the content of mats, nonwovens, and wovens made of natural and synthetic fibers can however reach values up to 80% by weight.

Organic phosphoric and/or phosphonic esters can be used as flame retardants. It is preferable to use compounds that are inert toward isocyanate groups. Among the preferred compounds are also phosphoric esters comprising chlorine. Examples of suitable flame retardants are tris(2-chloropropyl)phosphate, triethyl phosphate, diphenyl cresyl phosphate, diethyl ethanephosphonate, tricresyl phosphate, tris(2-chloroethyl)phosphate, tris(1,3-dichloropropyl)phosphate, tris(2,3-dibromopropyl)phosphate, tetrakis(2-chloroethyl)ethylenediphosphate, dimethyl methanephosphonate, diethyl diethanolaminomethylphosphonate, and also commercially available halogenated flame-retardant polyols.

It is also possible to use, alongside the above, flame retardants comprising bromine. Flame retardants used comprising bromine are preferably compounds which are reactive toward the isocyanate group. Examples of compounds of this type are esters of tetrabromophthalic acid with aliphatic diols, other examples being alkoxylation products of dibromobutenediol. It is also possible to use compounds that belong to the group of the brominated neopentyl compounds comprising OH groups.

Compounds that can also be used, other than the abovementioned halogen-substituted phosphates, for providing flame retardancy to the polyisocyanate polyaddition products are inorganic or organic flame retardants such as red phosphorus, aluminum oxide hydrate, antimony trioxide, arsenic oxide, ammonium polyphosphate, and calcium sulfate, expandable graphite, or cyanuric acid derivatives, e.g. melamine, or a mixture of at least two flame retardants, e.g. ammonium polyphosphates and melamine, and other compounds that may optionally be used are Corn starch or ammonium polyphosphate, melamine, and expandable graphite, and/or optionally aromatic polyesters. It has generally proven advantageous to use from 5 to 50 parts by weight, preferably from 5 to 25 parts by weight, of the flame retardants mentioned for every 100 parts by weight of component B).

Further details concerning the abovementioned other conventional auxiliaries and additives can be found in the technical literature, for example in the monograph by J. H. Saunders and K. C. Frisch “High Polymers”, volume XVI, Polyurethanes, parts 1 and 2, Verlag Interscience Publishers 1962 and 1964, or in the Kunststoff-Handbuch, Polyurethane, Band VII [Plastics handbook, Polyurethanes, volume VII], Hanser-Verlag, Munich, Vienna, 3^{rd} edition, 1993.

The mixing ratio of the components used is described by way of the isocyanate index. The isocyanate index is the equivalent ratio of isocyanate groups to groups reactive toward isocyanate, multiplied by 100. By way of example, an isocyanate index of 70 means that the number of reactive NCO groups in component A) for each reactive OH group in component B) to E) is 0.7, or that the number of reactive NCO groups in components B) to E) is 1.43 for each reactive NCO group in component A).

In one preferred embodiment of the invention, the amounts reacted of the polyisocyanates A) and component B) for producing the rigid polyurethane foams are such that the isocyanate index is in the range from 110 to 240, preferably from 120 to 210, particularly preferably from 130 to 180, specifically from 135 to 160, and in a specific case from 140 to 150. The isocyanate index is the molar ratio of isocyanate groups to groups reactive toward isocyanate groups, multiplied by 100. Lower reaction temperatures and improved mechanical properties are thus also achieved, in addition to surface improvement, in particular improvement of the upper foam surface.

In another embodiment, the present invention accordingly provides a process for producing composite elements as described above where component A) and component B) to E) are used in such a way that the isocyanate index is smaller than 180.

Application Apparatus

In the invention, the application process is achieved by means of a fixed application apparatus. It is particularly preferable that said fixed application apparatus is composed of at least one fixed tube c) provided with apertures f) and attached substantially parallel to the outer layer b) and substantially at right angles to the direction of movement of the outer layer b).

In another embodiment, the present invention accordingly provides a process for producing composite elements as described above where the fixed application apparatus c) is composed of at least one fixed tube c) provided with apertures f) and attached parallel to the outer layer b) and at right angles to the direction of movement of the outer layer b).

The at least one tube is particularly preferably one attached parallel to the outer layer b) and at right angles to the direction of movement of the outer layer b). For the purposes of the process of the invention, the at least one tube c) is a fixed tube, i.e. the angle between the longitudinal axis of the tube(s) and the direction of movement of the outer layer is constant, being in essence a right angle, or being a right angle. It is possible to use, as application apparatus, one tube or preferably a plurality of tubes attached alongside one another in a longitudinal direction.

The application apparatus is known from the prior art and is described by way of example in WO 2009/077490, the entire content of which is incorporated by way of reference into the present invention. The application apparatus is hereinafter also termed rake applicator.

In one preferred embodiment, the arrangement of at least two tubes c) provided with apertures f) is in particular such that they form a straight line. It is preferable to use from 2 to 4, particularly from 2 to 3, and in particular 2, tubes c) as application apparatus (rake applicator).

The rake applicator of the invention has, as described, a shape similar to that of a tube, with holes on the underside, distributed across the entire length, and with the reaction mixture intake either at one end of the tubes c) or preferably in the middle of these. If a plurality of tubes c) are used, it is preferable that the intake method used is identical for all of the tubes c).

The tubes c), or the tubes c) arranged alongside one another in a longitudinal direction, can together have a length which is equal to the width of the outer layer b). It is preferable that the length of the tube or of the tubes c) attached alongside one another in a longitudinal direction is smaller than the width of the outer layer b), in order to ensure that none of the reaction mixture is applied alongside the outer layer b). The arrangement here has the rake applicator in the middle over the outer layer b). It is preferable that the rake applicator covers at least 70% of the width of the outer layer b). If the width of the outer layer b) is 1.2 m, as is conventional for sandwich elements, there would be a width of 25 cm not covered by the rake applicator on each side.

It is preferable that the rake applicator covers at least 70%, particularly at least 80%, and in particular at least 95%, of the width of the outer layer b).

It is preferable that the height of the rake applicator above the outer layer b) is from 5 to 30 cm, preferably from 10 to 30 cm, in particular from 15 to 25 cm.

The number of apertures f) along the tube c) or along each tube c) is, depending on the length of the tube c), at least 2, preferably at least 6, particularly preferably from 10 to 50, and in particular from 20 to 40. It is preferable that the number of holes is an even number.

The diameters of the apertures f) are in the range from 0.5 to 10 mm, preferably from 1.0 mm to 4 mm. The distances of the apertures f) from one another are preferably from 5 to 200 mm, particularly preferably from 5 to 60 mm, and in particular from 10 to 30 mm. The distance, and the diameter, is preferably identical across the entire length of the tube c).

The internal diameter of the tube c), or of each tube, is from 0.2 to 5 cm, preferably 0.3 to 2.5 cm, and in particular from 0.2 to 2 cm.

In one particularly preferred embodiment, there are differences in the lengths of the apertures f) along the length of the tube(s) c). The expression “length of the apertures f)” means the distance that the mixture a*) has to travel from the interior of the tube c) until it is discharged from the tube c). This can be achieved in various ways. Firstly, the internal diameter of the tube c) can be altered. This is not preferred, since components of this type are difficult to produce and to clean.

It is preferable that the length of the apertures f) is altered by attaching a component or a plurality of components at the underside of the tube c) in such a way that the length of the holes varies in the desired manner. This measure actually changes the wall thickness of the tube c). The manner in which the hole lengths decrease, from the location of the input of the starting material for the isocyanate-based rigid foam a*) to the end, is not linear, but instead is exponential. The manner of lengthening of the apertures f) is usually such that the length decreases in the direction from the input of the mixture a*) to the ends of the tube c). When the input for the mixture a*) is in the middle of the tube c), therefore, the length of the apertures f) decreases in the direction toward the edges. When the input for the mixture a*) is at the edge of the tube c), the length of the apertures f) decreases in the direction from the input side to the other side.

In particular, the rake applicator, which is preferably composed of plastic, can be produced from a single component, i.e. in one piece. The length of the apertures varies as in the descriptions above, in that the lengths of the apertures are adapted by using tubular extensions at the underside of the tube.

The length of the apertures f) has preferably been selected in such a way that the ratio of the length of the apertures f) from the edge to the middle for each tube c) is from 1.1 to 10. The ratio is particularly preferably from 2.5 to 10, in particular from 5 to 10.

If a plurality of tubes c) are used, the variation of the length of the apertures f) is designed identically for all of the tubes c). Each of the tubes c) provided with apertures f) has connection to mixing equipment for the mixing of components of the flowable starting material for the isocyanate-based rigid foam a*). This is usually achieved by means of an input d) and e) situated therebetween. This takes the form of tube, and if a plurality of tubes c) are used, each has connection to the input. This can be achieved via a tube from which in turn there are connecting tubes running outward to the tubes c).

The diameter of the inputs d) is preferably constant. It is preferably from 4 to 30 mm, particularly preferably from 6 to 22 mm.

The design of the process of the invention is preferably such that the amount of the flowable starting material applied to the outer layer b) for the isocyanate-based rigid foam a*) is from 2 kg/min to 100 kg/min, preferably from 8 kg/min to 60 kg/min.

The viscosity at 25° C. of the flowable starting material for the isocyanate-based rigid foam a*) is preferably from 100 mPa*s to 4000 mPa*s, particularly preferably from 100 mPa*s to 3500 mPa*s, in particular from 200 to 2000 mPa*s.

In another embodiment, the present invention accordingly provides a process according to any of claims 1 to 12 where the viscosity at 25° C. of the liquid starting material for the rigid foam a*) is in the range from 100 mPa*s to 3500 mPa*s.

The process of the invention is particularly suitable for foams with a short cream time for the system. The cream time for the systems used for the process of the invention is preferably below 15 s, with preference below 12 s, with particular preference below 10 s, and in particular below 8 s, while the fiber time for the system is from 20 to 60 s. The expression cream time means the time between the mixing of the polyol component and isocyanate component and the start of the urethane reaction. The expression fiber time means the time from the mixing of the starting components for the foams to the juncture at which the reaction product is no longer flowable. The fiber time is adapted to be appropriate to the element thickness produced, and also to the speed of the twin belt.

It is preferable that the rigid foams of the invention are produced in continuously operating twin-belt systems. In these, a high-pressure machine is used to meter the polyol component and the isocyanate component and to mix these in a mixing head. Separate pumps can be used in advance to meter catalysts and/or blowing agents into the polyol mixture.

The reaction mixture is applied continuously to the lower outer layer. The upper outer layer and the lower outer layer with the reaction mixture run into the twin-belt system. In this, the reaction mixture foams and hardens. Once the material has left the twin-belt system, the continuous strand is cut apart to give the desired dimensions. It is thus possible to produce sandwich elements with metallic outer layers or insulation elements with flexible outer layers.

The starting components are mixed at a temperature of from 15 to 90° C., preferably of from 20 to 60° C., in particular of from 20 to 45° C. The reaction mixture can be poured into closed supportive molds by high- or low-pressure metering machinery. This technology is used by way of example to manufacture discrete sandwich elements.

The density of preferred layers made of rigid polyurethane foam is from 0.02 to 0.75 g/cm³, preferably from 0.025 to 0.24 g/cm³, and in particular from 0.03 to 0.1 g/cm³. The materials are particularly suitable as insulation material in the construction sector and in the sector of refrigerators and freezers, for example in the form of intermediate layer for sandwich elements, or for foams for insertion into refrigerator casings and chest-freezer casings.

The rigid foams produced by the process of the invention exhibit good surfaces with few defects, good adhesion, and good curing. At the same time, the mixture formed from components B) to E) has good shelf life of a number of months at 20° C. or 5° C.

The present invention further provides a composite element obtainable by a process as described above.

Combinations of preferred embodiments are within the scope of the present invention. This is in particular true in relation to the embodiments characterized as preferred for the individual components A) to E) of the present invention, and in relation to the combination of preferred components A) to E) with preferred embodiments of the application process.

Examples of embodiments of the present invention have been listed hereinafter, but do not restrict the present invention. In particular, the present invention also comprises these embodiments which result from the dependencies stated hereinafter, and thus from combinations.
1. A process for producing composite elements comprising at least one rigid foam layer a) and at least one outer layer b), at least comprising the following steps:
   (i) providing a flowable starting material a*)
   (ii) applying the flowable starting material a*) to the outer layer b) by means of a fixed application apparatus c) while the outer layer b) is moved continuously,
   where the starting material a*) comprises the following components:
   A) at least one polyisocyanate,
   B) at least one polyol,
   C) at least one blowing agent,
   D) catalyst composition comprising
      at least one compound D1) selected from the group consisting of metal carboxylates and N,N′,N″-tris(dimethylaminopropyl)hexahydrotriazine;
      at least one compound D2) which catalyzes polyurethane formation and which differs from the compound D1) and comprises at least one amino group, and
   E) optionally auxiliaries and additives,
   where component B) is one selected from polyetherols, and the starting material a*) is free from polyesterols.
2. The process according to embodiment 1, where the ratio by weight of the compound D2) to the compound D1) is greater than 8.
3. The process according to embodiment 1 or 2, where the amount used of the catalyst D1) is in the range from 0.1 to 2.5 parts by weight, based on 100 parts by weight of component B).
4. The process according to any of embodiments 1 to 3, where the amount used of the compound D2) is at least 0.1 part by weight, based on 100 parts by weight of component B).
5. The process according to any of embodiments 1 to 4, where the carboxylate is one selected from the group consisting of formate, octanoate, and acetate.
6. The process according to any of embodiments 1 to 5, where the catalyst composition comprises at least one potassium carboxylate and N,N′,N″-tris(dimethylaminopropyl)hexahydrotriazine.
7. The process according to any of embodiments 1 to 6, where the compound D2) is one selected from the group consisting of amidines, tertiary amines, and alkanolamines.
8. The process according to any of embodiments 1 to 7, where a mixture of
   b1) from 35 to 75 parts by weight of one or more high-functionality polyether alcohols with functionalities of from 3.5 to 5.5 and with a hydroxy number of from 400 to 550 mg KOH/g,
   b2) from 2 to 30 parts by weight of one or more polyether alcohols based on aliphatic amines with functionalities of from 3.5 to 4.5 and with a hydroxy number of from 450 to 900 mg KOH/g, and
   b3) from 15 to 35 parts by weight of one or more polyether alcohols with functionalities of from 1.5 to 3 and with a hydroxy number of from 150 to 450 mg KOH/g
   is used as component B).
9. The process according to embodiment 8, where the polyether alcohol(s) b3) has/have functionality/functionalities of from 2 to 3 and a hydroxy number of from 220 to 430 mg KOH/g.
10. The process according to any of embodiments 1 to 10, where component A) and component B) to E) are used in such a way that the isocyanate index is smaller than 180.
11. The process according to any of embodiments 1 to 10, where the blowing agent is one selected from the group consisting of n-pentane, isopentane, and water.
12. The process according to any of embodiments 1 to 11, where the fixed application apparatus c) is composed of at least one fixed tube c) provided with apertures f) and attached parallel to the outer layer b) and at right angles to the direction of movement of the outer layer b).
13. The process according to any of embodiments 1 to 12, where the viscosity at 25° C. of the liquid starting material for the rigid foam a*) is in the range from 100 mPa*s to 3500 mPa*s.
14. A composite element obtainable by a process according to any of embodiments 1 to 13.
15. A process for producing composite elements comprising at least one rigid foam layer a) and at least one outer layer b), at least comprising the following steps:
   (i) providing a flowable starting material a*)
   (ii) applying the flowable starting material a*) to the outer layer b) by means of a fixed application apparatus c) while the outer layer b) is moved continuously,
   where the starting material a*) comprises the following components:
   A) at least one polyisocyanate,
   B) at least one polyol,
   C) at least one blowing agent,
   D) catalyst composition comprising
      at least one compound D1) selected from the group consisting of metal carboxylates and N,N′,N″-tris(dimethylaminopropyl)hexahydrotriazine;
      at least one compound D2) which catalyzes polyurethane formation and which differs from the compound D1) and comprises at least one amino group, and
   E) optionally auxiliaries and additives,
   where component B) is one selected from polyetherols, and the starting material a*) is free from polyesterols,
   where component A) and component B) to E) are used in such a way that the isocyanate index is smaller than 180.
16. The process according to embodiment 15, where the ratio by weight of the compound D2) to the compound D1) is greater than 8.
17. The process according to embodiment 15 or 16, where the amount used of the catalyst D1) is in the range from 0.1 to 2.5 parts by weight, based on 100 parts by weight of component B).
18. The process according to any of embodiments 15 to 17, where the amount used of the compound D2) is at least 0.1 part by weight, based on 100 parts by weight of component B).
19. The process according to any of embodiments 15 to 18, where the carboxylate is one selected from the group consisting of formate, octanoate, and acetate. 20. The process according to any of embodiments 15 to 19, where the catalyst composition comprises at least one potassium carboxylate and N,N′, N″-tris(dimethylaminopropyl)hexahydrotriazine.
21. The process according to any of embodiments 15 to 20, where the compound D2) is one selected from the group consisting of amidines, tertiary amines, and alkanolamines.
22. The process according to any of embodiments 15 to 21, where a mixture of
   b1) from 35 to 75 parts by weight of one or more high-functionality polyether alcohols with functionalities of from 3.5 to 5.5 and with a hydroxy number of from 400 to 550 mg KOH/g,
   b2) from 2 to 30 parts by weight of one or more polyether alcohols based on aliphatic amines with functionalities of from 3.5 to 4.5 and with a hydroxy number of from 450 to 900 mg KOH/g, and
   b3) from 15 to 35 parts by weight of one or more polyether alcohols with functionalities of from 1.5 to 3 and with a hydroxy number of from 150 to 450 mg KOH/g
   is used as component B).
23. The process according to embodiment 22, where the polyether alcohol(s) b3) has/have functionality/functionalities of from 2 to 3 and a hydroxy number of from 220 to 430 mg KOH/g.
24. The process according to any of embodiments 15 to 23, where the blowing agent is one selected from the group consisting of n-pentane, isopentane, and water.
25. The process according to any of embodiments 15 to 24, where the fixed application apparatus c) is composed of at least one fixed tube c) provided with apertures f) and attached parallel to the outer layer b) and at right angles to the direction of movement of the outer layer b).
26. The process according to any of embodiments 15 to 25, where the viscosity at 25° C. of the liquid starting material for the rigid foam a*) is in the range from 100 mPa*s to 3500 mPa*s.
27. A composite element obtainable by a process according to any of embodiments 15 to 26.
28. A process for producing composite elements comprising at least one rigid foam layer a) and at least one outer layer b), at least comprising the following steps:
   (i) providing a flowable starting material a*)
   (ii) applying the flowable starting material a*) to the outer layer b) by means of a fixed application apparatus c) while the outer layer b) is moved continuously,
   where the starting material a*) comprises the following components:
   A) at least one polyisocyanate,
   B) at least one polyol,
   C) at least one blowing agent,
   D) catalyst composition comprising
      at least one compound D1) selected from the group consisting of metal carboxylates and N,N′,N″-tris(dimethylaminopropyl)hexahydrotriazine;
      at least one compound D2) which catalyzes polyurethane formation and which differs from the compound D1) and comprises at least one amino group, and
   E) optionally auxiliaries and additives,
   where component B) is one selected from polyetherols, and the starting material a*) is free from polyesterols,
   where the ratio by weight of the compound D2) to the compound D1) is greater than 8.
29. The process according to embodiment 28, where the amount used of the catalyst D1) is in the range from 0.1 to 2.5 parts by weight, based on 100 parts by weight of component B).
30. The process according to either of embodiments 28 and 29, where the amount used of the compound D2) is at least 0.1 part by weight, based on 100 parts by weight of component B).
31. The process according to any of embodiments 28 to 30, where the carboxylate is one selected from the group consisting of formate, octanoate, and acetate.
32. The process according to any of embodiments 28 to 31, where the catalyst composition comprises at least one potassium carboxylate and N,N′, N″-tris(dimethylaminopropyl)hexahydrotriazine.
33. The process according to any of embodiments 28 to 32, where the compound D2) is one selected from the group consisting of amidines, tertiary amines, and alkanolamines.
34. The process according to any of embodiments 28 to 33, where a mixture of
   b1) from 35 to 75 parts by weight of one or more high-functionality polyether alcohols with functionalities of from 3.5 to 5.5 and with a hydroxy number of from 400 to 550 mg KOH/g,
   b2) from 2 to 30 parts by weight of one or more polyether alcohols based on aliphatic amines with functionalities of from 3.5 to 4.5 and with a hydroxy number of from 450 to 900 mg KOH/g, and
   b3) from 15 to 35 parts by weight of one or more polyether alcohols with functionalities of from 1.5 to 3 and with a hydroxy number of from 150 to 450 mg KOH/g
   is used as component B).
35. The process according to embodiment 34, where the polyether alcohol(s) b3) has/have functionality/functionalities of from 2 to 3 and a hydroxy number of from 220 to 430 mg KOH/g.
36. The process according to any of embodiments 28 to 35, where component A) and component B) to E) are used in such a way that the isocyanate index is smaller than 180.
37. The process according to any of embodiments 28 to 36, where the blowing agent is one selected from the group consisting of n-pentane, isopentane, and water.
38. The process according to any of embodiments 28 to 37, where the fixed application apparatus c) is composed of at least one fixed tube c) provided with apertures f) and attached parallel to the outer layer b) and at right angles to the direction of movement of the outer layer b).
39. The process according to any of embodiments 28 to 38, where the viscosity at 25° C. of the liquid starting material for the rigid foam a*) is in the range from 100 mPa*s to 3500 mPa*s.
40. A composite element obtainable by a process according to any of embodiments 28 to 39.

The examples below are intended to provide further explanation of the invention.

### EXAMPLES

### 1. Comparative Example 1

The isocyanates, and also the components reactive toward isocyanate, were foamed together with the blowing agents, catalysts, and all of the other additives at a constant mixing ratio of polyol component to isocyanate of 100:150.

### 1.1 Polyol Component:

56.7 parts by weight of a polyether alcohol with a hydroxy number of 490 mg KOH/g, based on propylene oxide and a mixture of sucrose and glycerol as starter,
8.3 parts by weight of a polyether alcohol with a hydroxy number of 770 mg KOH/g, based on propylene oxide and ethylenediamine as starter,
20 parts by weight of castor oil,
12 parts by weight of tris-2-chloroisopropyl phosphate,
2 parts by weight of Tegostab® 88462 from Goldschmidt,
1.0 part by weight of water

### 1.2 Additives:

0.2 part by weight of potassium acetate in ethylene glycol, 47% solution (i.e. 0.1 part by weight of the catalytically active carboxylate)
7.5 parts by weight of n-pentane
3.8 parts by weight of dimethylcyclohexylamine for adjusting fiber times
about 1.2 parts by weight of water for adjusting foam density

### 1.3 Isocyanate Component:

150 parts by weight of Lupranat® M50 (polymeric methylenediphenyl diisocyanate (PMDI) with a viscosity of about 500 mPa*s at 25° C. from BASF SE)

### 1.4 Experimental Method

Sandwich elements of thickness 50 mm with aluminum foil of thickness 0.05 mm as outer layers were produced by the twin-belt process. Application apparatus used comprised two fixed pipes arranged alongside one another, in each case of length 560 mm, attached parallel to the outer layer at a distance of 90 mm and at right angles to the direction of movement of the outer layer, and each having 14 apertures. The intake of the flowable starting material was in the middle of the tubes, and the length of the apertures of the tubes decreased from the middle of the tubes to their ends. The total amount discharged of the reaction mixture was 13.2±0.5 kg/min. The envelope density of the foam here was adjusted to 36+/−1 g/L by varying the water content, while n-pentane content was constant at 7.5 parts by weight. Fiber time was moreover adjusted to 26+/−1 s by varying the proportion of dimethylcyclohexylamine.

### 2. Inventive Example 1

The isocyanates, and also the components reactive toward isocyanate, were foamed together with the blowing agents, catalysts, and all of the other additives at a constant mixing ratio of polyol component to isocyanate of 100:250.

### 2.1 Polyol Component:

56.7 parts by weight of a polyether alcohol with a hydroxy number of 490 mg KOH/g, based on propylene oxide and a mixture of sucrose and glycerol as starter,
8.3 parts by weight of a polyether alcohol with a hydroxy number of 770 mg KOH/g, based on propylene oxide and ethylenediamine as starter,
20 parts by weight of a polyether alcohol with a hydroxy number of 400 mg KOH/g, based on propylene oxide and glycerol as starter
12 parts by weight of tris-2-chloroisopropyl phosphate,
2 parts by weight of Tegostab® 88462 from Goldschmidt,
1.0 part by weight of water

### 2.2 Additives:

0.6 part by weight of potassium acetate in ethylene glycol, 47% solution (i.e. 0.3 part by weight of the catalytically active carboxylate)
11 parts by weight of n-pentane
4.8 parts by weight of dimethylcyclohexylamine for adjusting fiber times about 1.6 parts by weight of water for adjusting foam density

### 2.3 Isocyanate Component

250 parts by weight of Lupranat® M50 (polymeric methylenediphenyl diisocyanate (PMDI) with a viscosity of about 500 mPa*s at 25° C. from BASF SE)

### 2.4 Experimental Method

Sandwich elements of thickness 50 mm with aluminum foil of thickness 0.05 mm as outer layers were produced by the twin-belt process. Application apparatus used comprised two fixed pipes arranged alongside one another, in each case of length 560 mm, attached parallel to the outer layer at a distance of 90 mm and at right angles to the direction of movement of the outer layer, and each having 14 apertures. The intake of the flowable starting material was in the middle of the tubes, and the length of the apertures of the tubes decreased from the middle of the tubes to their ends. The total amount discharged of the reaction mixture was 13.2±0.5 kg/min. The envelope density of the foam here was adjusted to 36+/−1 g/L by varying the water content, while n-pentane content was constant at 11 parts by weight. Fiber time was moreover adjusted to 26+/−1 s by varying the proportion of dimethylcyclohexylamine.

### 3. Comparative Example 2

The isocyanates, and also the components reacted toward isocyanate, were foamed together with the blowing agents, catalysts, and all of the other additives with a constant mixing ratio of polyol component to isocyanate of 100:250.

### 3.1 Polyol Component:

56.7 parts by weight of a polyether alcohol with a hydroxy number of 490 mg KOH/g, based on propylene oxide and a mixture of sucrose and glycerol as starter,
8.3 parts by weight of a polyether alcohol with a hydroxy number of 770 mg KOH/g, based on propylene oxide and ethylenediamine as starter,
20 parts by weight of a polyether alcohol with a hydroxy number of 400 mg KOH/g, based on propylene oxide and glycerol as starter
12 parts by weight of tris-2-chloroisopropyl phosphate,
2 parts by weight of Tegostab® 88462 from Goldschmidt,
1.0 part by weight of water

### 3.2 Additives:

0.6 part by weight of potassium acetate in ethylene glycol, 47% solution (i.e. 0.3 part by weight of the catalytically active carboxylate)
11 parts by weight of n-pentane
4.8 parts by weight of dimethylcyclohexylamine for adjusting fiber times about 1.6 parts by weight of water for adjusting foam density

### 3.3 Isocyanate Component

250 parts by weight of Lupranat® M50 (polymeric methylenediphenyl diisocyanate (PMDI) with a viscosity of about 500 mPa*s at 25° C. from BASF SE)

### 3.4 Experimental Method

Sandwich elements of thickness 50 mm with aluminum foil of thickness 0.05 mm as outer layers were produced by the twin-belt process. The envelope density of the foam here was adjusted to 36+/−1 g/L by varying the water content, while n-pentane content was constant at 11 parts by weight. Fiber time was moreover adjusted to 26+/−1 s by varying the proportion of dimethylcyclohexylamine.

Application apparatus used comprised a tube (rake applicator) of length 25 cm and with internal diameter 10 mm, attached parallel to the outer layer and in the direction of running of the belts, and having 41 apertures of diameter 1.2 mm. The apertures had constant length and diameter over the length of the tube. The distance of the first aperture from the last aperture was 20 cm. The intake of the liquid reaction mixture was at end of the tube. The input amount was 13.2 kg/min+/−0.5 kg/min. The rake applicator oscillated during the application of the liquid reaction mixture over the element with the required sandwich element.

### 4. Results

The frequency of surface defects on the side that during production is upward was determined quantitatively via an optical method. For this, a plane surface was inserted into a foam specimen at a distance of one millimeter from the upper outer layer (side that during production is upward), and material above this was removed.

For quantitative assessment of the surface, the surface of the foam was illuminated from the right-hand side and then from the left-hand side, and in each case photographed. The images were superposed and analyzed with image-analysis software. The surface defects were visible as black areas here. The percentage of the black areas, based on the entire surface area, is a measure of the frequency of surface defects on the foam.

An additional qualitative assessment of the surface quality of the foams was also carried out, by removing the outer layer from a foam specimen measuring 1 m×2 m and visual assessment of, and classification of, the surface.

Table 1 shows the results.

TABLE 1

| | | Comparative | Inventive | Comparative |
|---|---|---|---|---|
| | | example 1 | example 1 | example 2 |
| Surface of the | | Poor/ | very good | Poor/ |
| side that during | | unsatisfactory | | unsatisfactory |
| production is | | | | |
| upward, qualitative | | | | |
| assessment | | | | |
| Surface of the | % | 4.7 | 0.9 | 3.8 |
| side that during | | | | |
| production is | | | | |
| upward, quantitative | | | | |
| assessment | | | | |
| Fixed applicator | | yes | yes | no |
| apparatus | | | | |
| Potassium acetate | parts | 0.235 | 0.282 | 0.282 |
| | by | | | |
| | wt. | | | |
| Mixing ratio 100: | | 150 | 250 | 250 |

The results in table 1 show that the frequency of formation of surface defects on the side that during production is upward, at the interface with the metallic outer layer, has been markedly reduced in the inventive example. When a non-fixed application apparatus is used but the experimental method is in other respects the same as in inventive example 1, the surface is significantly impaired.

1. A process for producing a composite element comprising a rigid foam layer a) and an outer layer b), the process comprising: applying a flowable starting material a*) to the outer layer b) with a fixed application apparatus c) while the outer layer b) is moved continuously,
wherein:
the starting material a*) comprises:
A) a polyisocyanate;
B) a one polyol;
C) a blowing agent;
D) a catalyst composition, comprising
at least one compound D1) selected from the group consisting of a metal carboxylate and N,N′,N″-tris(dimethylaminopropyl)hexa hydrotriazine; and
at least one compound D2) which catalyzes polyurethane formation and which differs from the compound D1) and comprises at least one amino group; and
E) optionally an auxiliary and an additive;
the polyol B) is a polyetherol; and
the starting material a*) does not contain a polyesterol.

2. The process according to claim 1, wherein a ratio by weight of the compound D2) to the compound D1) is greater than 8.

3. The process according to claim 1, wherein an amount of the catalyst D1) ranges from 0.1 to 2.5 parts by weight, based on 100 parts by weight of the component B).

4. The process according to claim 1, wherein an amount of the compound D2) is at least 0.1 part by weight, based on 100 parts by weight of the component B).

5. The process according to claim 1, wherein the compound D1) is at least one carboxylate selected from the group consisting of formate, ethylhexanoate, and acetate.

6. The process according to claim 1, wherein the catalyst composition comprises at least one potassium carboxylate and N,N′,N″-tris(dimethylaminopropyl)hexahydrotriazine.

7. The process according to claim 1, wherein the compound D2) is at least one selected from the group consisting of an amidine, a tertiary amine, and an alkanolamines.

8. The process according to claim 1, wherein the component B) comprises a mixture of
b1) from 35 to 75 parts by weight of one or more high-functionality polyether alcohols with functionalities of from 3.5 to 5.5 and with a hydroxy number of from 400 to 550 mg KOH/g,
b2) from 2 to 30 parts by weight of one or more polyether alcohols based on aliphatic amines with functionalities of from 3.5 to 4.5 and with a hydroxy number of from 450 to 900 mg KOH/g, and
b3) from 15 to 35 parts by weight of one or more polyether alcohols with functionalities of from 1.5 to 3 and with a hydroxy number of from 150 to 450 mg KOH/g.

9. The process according to claim 8, wherein the one or more polyether alcohols have a functionality of from 2 to 3 and a hydroxy number of from 220 to 430 mg KOH/g.

10. The process according to claim 1, wherein an isocyanate index of the starting material a*) is smaller than 180.

11. The process according to claim 1, wherein the blowing agent is selected from the group consisting of n-pentane, isopentane, and water.

12. The process according to claim 1, wherein the fixed application apparatus c) comprises a fixed tube c) provided with apertures f) and attached parallel to the outer layer b) and at right angles to a direction of movement of the outer layer b).

13. The process according to claim 1, wherein the starting material a*) is a liquid starting material a*) in the form of a rigid foam having a viscosity at 25° C. ranging from 100 mPa*s to 3500 mPa*s.

14. A composite element obtainable by the process according to claim 1.
